(19) United States
(12) Patent Application Publication
(10) Pub. No.: US 2003/0191569 A1
(43) Pub. Date: Oct. 9, 2003

(54) Vehicular monitor actuating device and method

(76) Inventors: Wen-Wei Su, Hsinchu (TW); Kuei-Hung Chen, Taipei (TW); Shun-Hsiang Hsiao, Miaoli (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/407,032

(22) Filed: Apr. 3, 2003

(30) Foreign Application Priority Data
Apr. 4, 2002 (TW) 091106814

(51) Int. Cl. G06F 17/00

(52) U.S. Cl. 701/49; 701/36

(57) ABSTRACT

A vehicular monitor is controlled by either a manual control device or an automatic control device. In response to an activation state of one of the manual control device and the automatic control device, a first actuating signal is asserted to adjust the working condition of the vehicular monitor according to the first actuating signal. In response to an activation state of the other of the manual control device and the automatic control device, the first actuating signal is asserted and a second actuating signal is asserted in stead to adjust the working condition of the vehicular monitor according to the second actuating signal. The vehicular monitor is for example a rearview mirror, a camera or a display. The working condition of the vehicular monitor is adjusted for example by moving or rotating the rearview mirror, changing focus of camera or zooming in/out the display.

### FIELD OF THE INVENTION

The present invention related to a vehicular monitor actuating and more particularly to a vehicular monitor actuating device for use with a vehicular monitor, a-manual control device and a vehicle status indicator.

### BACKGROUND OF THE INVENTION

When a driver is seated in a vehicle, he should adjust all of the interior and exterior rearview mirrors according to his need. The rearview mirror can be adjusted manually or automatically by pushing buttons. After the adjustment of rearview mirrors is done, the view angle of each rearview mirror seen by the driver is constant, and it is difficult and also dangerous for the driver to further change the view angles while driving.

Therefore, rearview mirror control devices for automatically adjusting the view angle of a rearview mirror were developed to solve this problem. For example, when a driver would like to change to another lane, turn to another direction or overtaking a car, he will need to realize out the situation of the adjacent lane to see whether there is any vehicle oncoming. Therefore, the horizontally turning of the rearview mirror toward the target lane will be helpful for the lane-changing or overtaking operation. In addition, while moving up or down a slope, it is advantageous to turn the rearview mirror vertically to obtain a view range similar to that on the flat road. Taiwanese patent application Publication No. 388377 suggested such a rearview-mirror automatic control device, incorporated herein for reference.

FIG. 1 schematically shows the prior art device for actuating a rearview mirror in response to the activation of the indicator light The actuating device uses a relay controller 33 to cut off the electric connection between the manual switch 12 and the rearview mirror 34 when the view angle of the rearview mirror 34 is adjusted by a micro-controller 31 in response to the activation of an indicator light 30. Under this circumstance, once the controller 31 adjusts the view angle of the rearview mirror 34 via the relay device 33, the manual switch 12 will be totally disabled. In other words, the view-angle adjustment of the rearview mirror cannot be interrupted manually even when necessary or emergency situation occurs. It thus renders inconvenience and danger in another aspect.

### SUMMARY OF THE INVENTION Therefore, an objective of the present invention is to arbitrarily automatically or manually control the rearview mirror to be according to practical needs.

A first aspect of the present invention relates to a vehicular monitor actuating device for use with a vehicular monitor. The vehicular monitor is actuated by the vehicular monitor actuating device in a first situation and by a manual control device in a second situation. The vehicular monitor actuating device comprises a micro-controller in communication with the manual control device, asserting a first actuating signal in the first situation, and suspending the first actuating signal and asserting a second actuating signal in the second situation; and an actuating signal channel in communication with the micro-controller and the vehicular monitor for transmitting therethrough the first or the second signal to the vehicular monitor for changing a working condition of the vehicular monitor.

In an embodiment, the first situation is determined by an output of a vehicle status indicator. The vehicle status indicator is, for example, an electronic compass, a global positioning system (GPS), a steering-wheel turning detector, a tire-angle switch, a vehicle stability control (VSC) system, an electronic stability program (ESP), a yaw sensor, an attitude indicator, an accelerating indicator, a mercury switch, a reverse gear sensor or a back-warning radar.

In an embodiment, the second situation is determined by manually operating a switch.

Preferably, the suspended first actuating signal is recovered after the second actuating signal is completed.

The actuating signal channel, for example, can be vehicle cables, vehicular digital bus or wireless transmission channel.

The vehicular monitor, for example, can be a rearview mirror, a CCD or a CMOS camera or a display. The working condition is changed by moving or rotating the rearview mirror or camera, changing focus of the camera or zooming the display.

A vehicular monitor actuating device for use with a vehicular monitor actuated by the vehicular monitor actuating device in a first situation and by a manual control device in a second situation according to a second aspect of the present invention, comprises a micro-controller in communication with the manual control device, asserting a first actuating signal in the second situation, and suspending the first actuating signal and asserting a second actuating signal in the first situation; and an actuating signal channel in communication with the micro-controller and the vehicular monitor for transmitting therethrough the first or the second signal to the vehicular monitor for changing a working condition of the vehicular monitor.

A third aspect of the present invention relates to a method for actuating a vehicular monitor. The vehicular monitor is controlled by either a manual control device or an automatic control device. The method comprises steps of asserting a first actuating signal in response to an activation state of one of the manual control device and the automatic control device; adjusting a working condition of the vehicular monitor according to the first actuating signal; suspending the first actuating signal in response to an activation state of the other of the manual control device and the automatic control device, and asserting a second actuating signal in stead; and adjusting a working condition of the vehicular monitor according to the second actuating signal.

In an embodiment, the first actuating signal is asserted in response to the activation state of the automatic control device, and the second actuating signal is asserted in response to the activation state of the manual control device.

Alternatively, the first actuating signal is asserted in response to the activation state of the manual control device, and the second actuating signal is asserted in response to the activation state of the automatic control device.

### BRIEF DESCRIPTION OF DRAWINGS

The above objects and advantages of the present invention will become more readily apparent to those ordinarily skilled in the art after reviewing the following detailed description and accompanying drawings, in which:

FIG. 1 is a schematic circuit block diagram showing a prior art device for actuating a rearview mirror in response to the activation of the indicator light;

FIG. 2 is a schematic circuit block diagram showing a device for actuating a vehicular monitor in response to the activation of the vehicle status indicator;

FIG. 3A is a waveform diagram illustrating the actuating signals for automatically actuating the vehicular monitor between different working conditions with no manual interruption; and

FIG. 3B is a waveform diagram illustrating the actuating signals for automatically actuating the vehicular monitor between different working conditions with manual interruption.

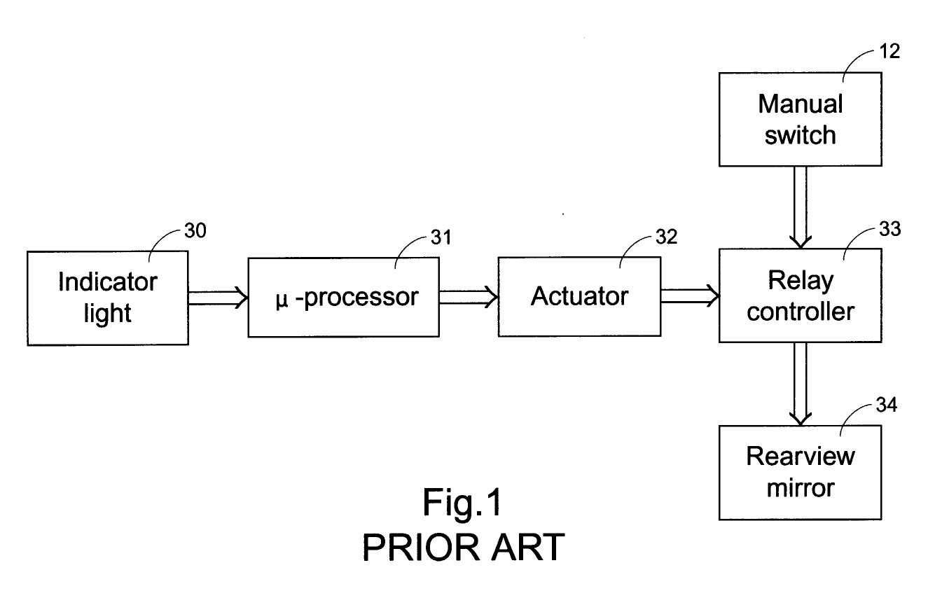

### DETAILED DESCRIPTION OF PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

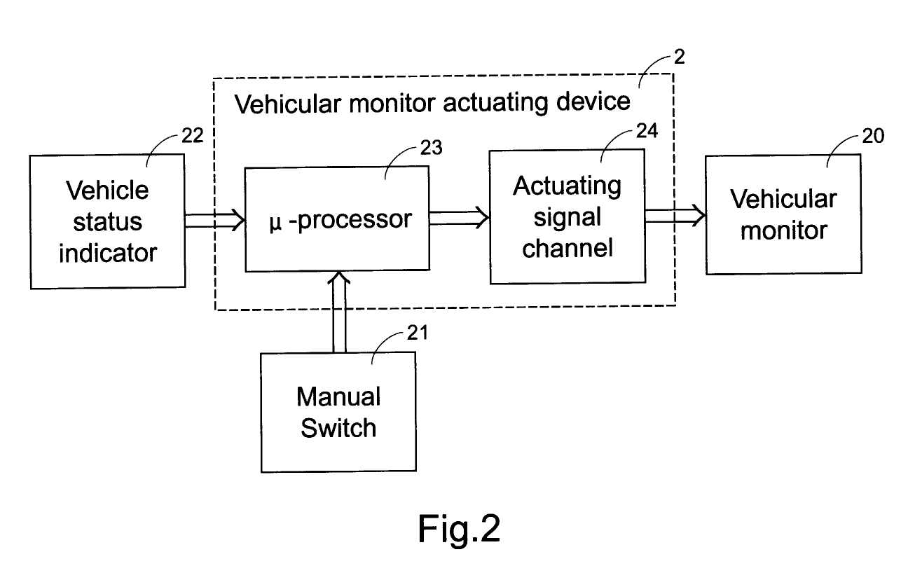

Please refer to FIG. 2. The vehicular monitor actuating device 2 according to the present invention includes a micro-processor 23 in communication with a vehicle status indicator 22 and a manual control device 21, and an actuating signal channel 24 in communication with the micro-processor 23 and a vehicular monitor 20.

The vehicular monitor, for example, can be a rearview mirror, a CCD or CMOS camera or a planar display such as LCD. Before driving, each of the vehicular monitor 20 is adjusted manually via the manual control device 21 such as a manual push button or a manual switch to a proper working condition. For example, for a rearview mirror, it should be moved or rotated to have a proper view angle from the driver's eyes. For the camera, it should be properly focused on a desired area. For the display, a proper view range should be shown. During the vehicle is running, it is the vehicular monitor actuating device 2 responsible for the view-range adjustment of the vehicular monitor 20. In this embodiment, the vehicular monitor actuating device 2 adjusts the view-range adjustment of the vehicular monitor 20 according to the output of the vehicle status indicator 22.

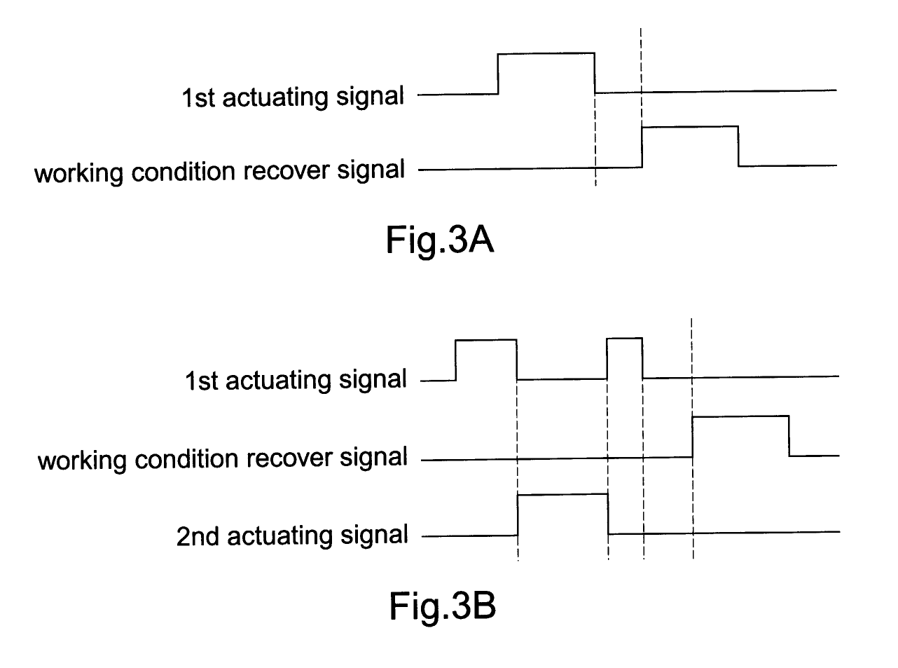

The vehicle status indicator 22 outputs a signal indicative of the direction that the vehicle is moving or is going to move or the slope change that the vehicle is encountering with. In response to the signal outputted by the vehicle status indicator 22, the microprocessor 23 asserts a working condition change signal, i.e. the first actuating signal shown in FIG. 3A, to the vehicular monitor 20 via the actuating signal channel 24. The vehicular monitor 20 is then adjusted to another working condition to have a proper view angle.

For example, the first actuating signal is asserted when the signal outputted by the vehicle status indicator 22 informs of a turning operation, a ready-to-turn operation, a backing-up operation, a ready-to-back-up operation, an ascending or a descending operation, a ready-to-overtake operation or the like. The vehicle status indicator 22, for example, can be an electronic compass, a global positioning system (GPS), a steering-wheel turning detector, a tire-angle switch, a vehicle stability control (VSC) system, an electronic stability program (ESP), a yaw sensor, an attitude indicator, an accelerating indicator, a mercury switch, a reverse gear sensor or a back-warning radar in order to achieve the above purpose.

In response to the first actuating signal, the vehicular monitor 20 is moved, rotated, focus-changed or zoomed in/out as mentioned above to another working condition in order to have a view range suitable for the turning, backing-up, ascending/descending or overtaking operation. Once the above operation is complete, a working condition recover signal is asserted by the micro-processor 23 to have the vehicular monitor return to the original working condition, i.e. the original position, focus or range.

According to the present invention, if there is any necessary or emergency situation occurs during the change of working conditions, the working condition change can be interrupted by manipulating the manual control device 21. Meanwhile, the processor 23 asserts a second actuating signal, which is another working condition change signal or a working condition recover signal, in response to the activation of the manual control device 21. The second actuating signal is also transmitted to the vehicular monitor 20 via the actuating signal channel 24 for view range adjustment of the vehicular monitor 20. Then, referring to FIG. 3B, the first actuating signal is recovered and continues to be transmitted to the vehicular monitor 20 after the second actuating signal is completed.

For example, when the vehicle is going to turn right so as to activate the right-side indicator light, at least the right-side exterior rearview mirror will be automatically rotated counterclockwise in response to the activation of the right-side indicator light in order to enlarge the view angle at the right side. The counterclockwise rotation is scheduled to proceed from a normal working position to a temporary working position. Before the rearview mirror reaches that temporary working position, the driver can manipulate the manual control device to suspend the rotation of the rearview mirror to the temporary working position, and in stead turn the rearview mirror downwards in order to clearly see the situation on the ground. After the downward movement of: the rearview mirror is complete, the rearview mirror continues to be rotated to the temporary working position from the suspended position.

Of course, it can be alternatively designed not to continue the suspended operation of the rearview mirror, but have the rearview mirror return to the normal working position. Similar illustration can be applied to other vehicular monitors such as cameras and displays. The cameras, for example, can be CCD or CMOS cameras using CCD or CMOS sensors to pick up image.

In the above embodiment, the actuating signal asserted in response to the output of the vehicle status indicator can be interrupted by the actuating signal asserted in response to the activation of the manual control device. Alternatively, the actuating signal asserted in response to the activation of the manual control device can be interrupted by the actuating signal asserted in response to the output of the vehicle status indicator, then recovered after the interrupting actuating signal is completed.

As mentioned above, the first or the second actuating signal is transmitted to the vehicular monitor 20 via the actuating signal channel 24. Conventional wiring cables can be used as the actuating signal channel 24. Alternatively and preferably, a vehicular digital bus such as a controller area network (CAN) bus or a vehicle area network (VAN) bus can be used in stead. Another option is to use the wireless transmission channel to transmit the actuating signal.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

We claim:

1. A vehicular monitor actuating device for use with a vehicular monitor, said vehicular monitor being actuated by said vehicular monitor actuating device in a first situation and by a manual control device in a second situation, said vehicular monitor actuating device comprising:
a micro-controller in communication with said manual control device, asserting a first actuating signal in said first situation, and suspending said first actuating signal and asserting a second actuating signal in said second situation; and
an actuating signal channel in communication with said micro-controller and said vehicular monitor for transmitting therethrough said first or said second signal to said vehicular monitor for changing a working condition of said vehicular monitor.

2. The vehicular monitor actuating device according to claim 1 wherein said first situation is determined by an output of a vehicle status indicator.

3. The vehicular monitor actuating device according to claim 2 wherein said vehicle status indicator is selected from a group consisting of an electronic compass, a global positioning system (GPS), a steering-wheel turning detector, a tire-angle switch, a vehicle stability control (VSC) system, an electronic stability program (ESP), a yaw sensor, an attitude indicator, an accelerating indicator, a mercury switch, a reverse gear sensor and a back-warning radar.

4. The vehicular monitor actuating device according to claim 1 wherein said second situation is determined by manually operating a switch.

5. The vehicular monitor actuating device according to claim 1 wherein said suspended first actuating signal is recovered after said second actuating signal is completed.

6. The vehicular monitor actuating device according to claim 1 wherein said actuating signal channel is selected from vehicle cables, vehicular digital bus and wireless transmission channel.

7. The vehicular monitor actuating device according to claim 6 wherein said vehicular digital bus is a controller area network (CAN) bus or a vehicle area network (VAN) bus.

8. The vehicular monitor actuating device according to claim 1 wherein said vehicular monitor is selected from a rearview mirror, a camera and a display.

9. The vehicular monitor actuating device according to claim 8 wherein said camera is a CCD camera or a CMOS camera.

10. The vehicular monitor actuating device according to claim 1 wherein said working condition is changed by moving said vehicular monitor, rotating said vehicular monitor, changing focus of said vehicular monitor or zooming said vehicular monitor.

11. A vehicular monitor actuating device for use with a vehicular monitor, said vehicular monitor being actuated by said vehicular monitor actuating device in a first situation and by a manual control device in a second situation, said vehicular monitor actuating device comprising:
a micro-controller in communication with said manual control device, asserting a first actuating signal in said second situation, and suspending said first actuating signal and asserting a second actuating signal in said first situation; and
an actuating signal channel in communication with said micro-controller and said vehicular monitor for transmitting therethrough said first or said second signal to said vehicular monitor for changing a working condition of said vehicular monitor.

12. The vehicular monitor actuating device according to claim 11 wherein said first situation is determined by an output of a vehicle status indicator, and said second situation is determined by manually operating a switch.

13. The vehicular monitor actuating device according to claim 12 wherein said vehicle status indicator is selected from a group consisting of an electronic compass, a global positioning system (GPS), a steering-wheel turning detector, a tire-angle switch, a vehicle stability control (VSC) system, an electronic stability program (ESP), a yaw sensor, an attitude indicator, an accelerating indicator, a mercury switch, a reverse gear sensor and a back-warning radar.

14. The vehicular monitor actuating device according to claim 11 wherein said actuating signal channel is selected from vehicle cables, vehicular digital bus and wireless transmission channel.

15. The vehicular monitor actuating device according to claim 14 wherein said vehicular digital bus is a controller area network (CAN) bus or a vehicle area network (VAN) bus.

16. The vehicular monitor actuating device according to claim 11 wherein said vehicular monitor is selected from a rearview mirror, a camera and a display.

17. The vehicular monitor actuating device according to claim 16 wherein said camera is a CCD camera or a CMOS camera.

18. A method for actuating a vehicular monitor, said vehicular monitor being controlled by either a manual control device or an automatic control device, said method comprising steps of:
asserting a first actuating signal in response to an activation state of one of said manual control device and said automatic control device;
adjusting a working condition of said vehicular monitor according to said first actuating signal;
suspending said first actuating signal in response to an activation state of the other of said manual control device and said automatic control device, and asserting a second actuating signal in stead; and
adjusting a working condition of said vehicular monitor according to said second actuating signal.

19. The method according to claim 18 wherein said automatic control device is selected from a group consisting of an electronic compass, a global positioning system (GPS), a steering-wheel turning detector, a tire-angle switch, a vehicle stability control (VSC) system, an electronic stability program (ESP), a yaw sensor, an attitude indicator, an accelerating indicator, a mercury switch, a reverse gear sensor and a back-warning radar.

20. The method according to claim 18 wherein said first actuating signal is asserted in response to said activation state of said automatic control device, and said second actuating signal is asserted in response to said activation state of said manual control device.

21. The method according to claim 18 wherein said first actuating signal is asserted in response to said activation state of said manual control device, and said second-actuating signal is asserted in response to said activation state of said automatic control device.

22. The method according to claim 18 wherein said vehicular monitor is selected from a rearview mirror, a CCD or CMOS camera and a display.

23. The method according to claim 18 wherein said working condition of said vehicular monitor is adjusted by moving said vehicular monitor, rotating said vehicular monitor, changing focus of said vehicular monitor or zooming said vehicular monitor.

24. The method according to claim 18 wherein said first or second actuating signal is transmitted via a vehicular cable, a controller area network (CAN) or vehicle area network (VAN) bus or a wireless transmission channel to adjust said working condition of said vehicular monitor.
